(19) United States
(12) Patent Application Publication
(10) Pub. No.: US 2023/0306258 A1
(43) Pub. Date: Sep. 28, 2023

(54) TRAINING VIDEO DATA GENERATION NEURAL NETWORKS USING VIDEO FRAME EMBEDDINGS

(71) Applicant: DeepMind Technologies Limited, London (GB)

(72) Inventors: Ioannis Alexandros Assael, London (GB); Brendan Shillingford, London (GB)

(21) Appl. No.: 18/020,856

(22) PCT Filed: Sep. 8, 2021
(86) PCT No.: PCT/EP2021/074721

§ 371 Date: Feb. 10, 2023

(30) Foreign Application Priority Data
Sep. 11, 2020 (GR) 20200100556

(51) Int. Cl. G06N 3/08

(52) U.S. Cl. CPC G06N 3/08

(57) ABSTRACT

Methods, systems, and apparatus, including computer programs encoded on a computer storage medium, for training a video data generation neural network having a plurality of video generation network parameters. In one aspect, a method includes generating one or more sequences of training video frames using the video data generation neural network in accordance with current values of the video data generation network parameters; obtaining one or more sequences of target video frames; and training the video data generation neural network using training signals derived from a similarity between respective embeddings of the training and target video frames. The embeddings are generated by a video data embedding neural network.

### CROSS-REFERENCE TO RELATED APPLICATION

This application claims priority to GR national application No. 20200100556, filed on Sep. 11, 2020. The disclosure of the prior application is considered part of and is incorporated by reference in the disclosure of this application.

### BACKGROUND

This specification relates to training neural networks to generate video data.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of weights.

### SUMMARY

This specification describes a system implemented as computer programs on one or more computers in one or more locations that trains a neural network to generate video data using training signals derived by using another, already trained video data embedding neural network.

In general, one innovative aspect of the subject matter described in this specification can be embodied in a method for training a video data generation neural network having a plurality of video generation network parameters, the method comprising: generating one or more sequences of training video frames using the video data generation neural network in accordance with current values of the video data generation network parameters; obtaining one or more sequences of target video frames; and training the video data generation neural network using a video data embedding neural network configured to generate an embedding of a video frame, the training comprising: generating a respective embedding of each of the training video frames by processing the training video frame using the video data embedding neural network; generating a respective embedding of each of the target video frames by processing the target video frame using the video data embedding neural network; determining a similarity between the respective embeddings of the training video frames and the respective embeddings of the target video frames; and determining an update to the current values of the video data generation network parameters based on determining a gradient with respect to the video data generation network parameters of an objective function that includes a term that depends on the similarity.

Determining the similarity between the embedding of the training video frame and the embedding of the target video frame may comprise: computing a Frechet Distance between the respective embeddings of the training video frames and the respective embeddings of the target video frames.

The video data generation neural network may be configured to generate the training video frame based on processing an input video frame in accordance with the current values of the video data generation network parameters.

The target video frame may be an upsampled version of the input video frame.

The target video frame may comprise an additional content item compared to the input video frame.

The target video frame may be a compressed version of the input video frame.

Determining the update to the current values of the video data generation network parameters may comprise: backpropagating the gradient of the objective function through video data embedding network parameters of the video data embedding neural network into the video data generation network parameters of video generation neural network.

The video data embedding network may be part of a trained video processing neural network.

The video processing neural network may comprise one or more volumetric convolutional neural network layers each including a plurality of three-dimensional filters.

The video processing neural network may further comprise an output subnetwork configured to generate a video processing network output by processing the embedding generated by the video data embedding neural network, the output subnetwork comprising at least an output layer.

The training may comprise training the video data generation neural network on a single sequence of training video frames and a single sequence of target video frames that is a ground truth output corresponding to the sequence of training video frames, and wherein the similarity may be a pair-wise similarity between the embedding of each training video frame and the embedding of a corresponding target video frame.

The training may comprise training the video data generation neural network on a plurality of sequences of training video frames and a plurality of sequences of target video frames, and wherein the similarity may be a collective similarity between the embeddings of the training video frames and the embeddings of the target video frames.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages.

Training a neural network to generate high quality (e.g., realistic, continuous, or high resolution) video data can be hard because selecting an effective training objective can be difficult. In particular, objective functions that sufficiently evaluate spatio-temporal relationships between a pair of videos, e.g., instead of per-frame, spatial-level relationships, can be difficult to formulate. Additionally, some objective functions are non-differentiable in nature and are thus unsuitable for use in gradient-based training scheme.

The described techniques allow a video data generation neural network to effectively be trained using a supervised training objective computed based on using a video data embedding network to process video data generated by the video data generation neural network and a set of target video data. Training signals provided by this supervised training objective can encourage the neural network to generate similar video data to the target video data.

The described techniques can effectively train the neural network to achieve state of the art performance in generating video data in a much more computationally efficient manner than existing training techniques, e.g., techniques that use unsupervised, self-supervised, or adversarial training losses. The described techniques can also be used to train the video generation neural network by using any of a variety of target video data, even when the training video (i.e., the video generated by the video data generation neural network) and the target video are not temporally aligned, or do not depict corresponding contents.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is a flow diagram of an example process for training the video data generation neural network.

FIG. 3 is a flow diagram of an example process for determining an update to the current values of the video data generation network parameters based on a similarity between the embeddings.

Like reference numbers and designations in the various drawings indicate like elements.

### DETAILED DESCRIPTION

This specification describes a system implemented as computer programs on one or more computers in one or more locations that trains a neural network to generate video data using training signals derived by using another, already trained video data embedding neural network.

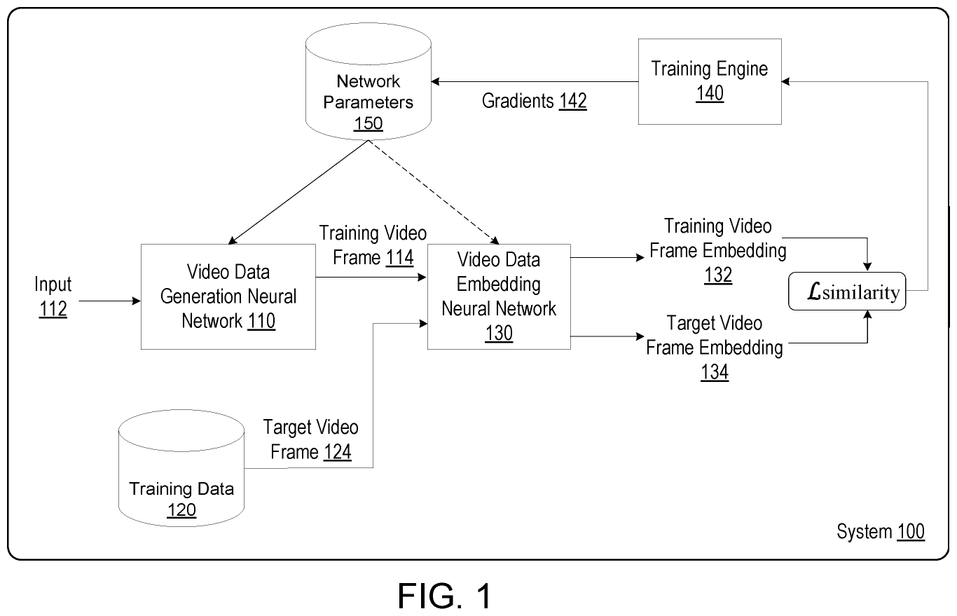

FIG. 1 shows an example system 100. The system 100 is an example of a system implemented as computer programs on one or more computers in one or more locations in which the systems, components, and techniques described below are implemented.

Generally the system 100 can train the video data generation neural network 110 to generate any kind of video data in any of a variety of ways.

For example, the neural network 110 can be trained to predict upcoming video frames that will follow a given video having one or more video frames. That is, the neural network 110 is configured to receive as input 112 a temporal sequence of video frames and generate a predicted video frame that is a prediction of the next video frame in the sequence, i.e., the video frame that will follow the last video frame in the temporal sequence of video frames. The sequence of video frames is referred to in this specification as a temporal sequence because the video frames in the sequence are ordered according to the time at which the frames were captured.

As another example, the video data generation neural network 110 can be trained to generate as output one or more new video frames from an input 112 including one or more given video frames. In various cases, the new video frame and the given video frame may depict different contents or have different resolutions. For example, the new video frame can be an upsampled or downsampled (e.g., compressed) version of the given video frame. As another example, the new video frame can depict an additional content item compared to the given video frame.

The system 100 maintains a set of training data 120 for use in training the video data generation neural network 110. The training data 120 can include target video data, i.e., data specifying corresponding ground truth videos that the network is being trained to generate. Instead of or in addition to corresponding ground truth data, the training data 120 can also include any other existing video that may facilitate effective training, e.g., by providing richer training signals. For example, such data can include readily available videos that have been considered, e.g., by a user of the system, analogous to target videos that the neural network 110 should generate.

The system can receive the training data 120 for training the neural network in any of a variety of ways. For example, the system can receive training data 120 as an upload from a remote user of the system over a data communication network, e.g., using an application programming interface (API) made available by the system. As another example, the system can receive an input from a user specifying which data that is already maintained by the system should be used for training the neural network.

To assist in the training of the video data generation neural network 110, the system 100 makes use of another, already trained video data embedding neural network 130, i.e., a network that has been trained to generate embeddings from input video frames.

The video data embedding neural network 130 is configured to process an input video frame to generate an embedding of the input video frame. Typically, an embedding of a video frame is a numeric representation in a latent space that has a fixed dimensionality. That is, the embedding is an ordered collection of numeric or other values that has a fixed number of values. For example, the embedding can be a tensor, i.e., a multidimensional array of numeric values. For example, the numeric values can define a respective distribution, e.g., a Gaussian distribution, over a set of possible values for each of a predetermined set of latent factors that can represent different features of the input video frame.

The video data embedding neural network 130 can have any appropriate architecture that allows the video data embedding neural network 130 to map one or more input video frames to an embedding. In other words, when generating the embedding for each particular frame, the neural network 130 with an appropriate architecture can also make use of information derived from neighboring (i.e., preceding or subsequence) frames of the particular frame. For example, the neural network can be a neural network that includes one or more volumetric convolutional layers, one or more recurrent layers, or both. Each volumetric convolutional layer generally includes a plurality of three-dimensional convolutional filters, i.e., filters with a kernels operating over two spatial dimensions and a time dimension. This can help to capture the spatiotemporal relationships present between different frames of a video. For example, the neural network can be a CNN-LSTM network, ConvLSTM network, or a volumetric CNN. As another example, the neural network can be an attention-based neural network (e.g., as described in Vaswani, Ashish, et al. “Attention is all you need.” Advances in neural information processing systems. 2017). An attention-based network generally refers to any neural network that applies an attention mechanism over received inputs (e.g., at one or more layers of the neural network) while transducing a video frame to an embedding.

In some implementations, the video data embedding neural network 130 is part of a larger (or deeper) neural network made up of additional network components. For example, the video data embedding neural network 130 can be a subnetwork of a larger neural network that is configured to perform video classification or frame prediction tasks. In such implementations, the larger neural network can also include an output subnetwork (e.g., that includes at least an output layer) configured to generate a video processing network output by processing the embedding generated by the video data embedding neural network 130. For example, the larger neural network can have an Inflated 3D ConvNet architecture (as described in Carreira, Joao, and Andrew Zisserman. “Quo vadis, action recognition? a new model and the kinetics dataset.” Proceedings of the IEEE Conference on Computer Vision and Pattern Recognition. 2017), a ResNet 3D architecture (as described in Hara, Kensho, Hirokatsu Kataoka, and Yutaka Satoh. “Learning spatio-temporal features with 3D residual networks for action recognition.” Proceedings of the IEEE International Conference on Computer Vision Workshops. 2017), or a Vision to Phoneme architecture (as described in Shillingford, Brendan, et al. “Large-scale visual speech recognition.” arXiv preprint arXiv:1807.05162 (2018)).

A training engine 140 can use the training data 120 and the video data embedding neural network 130 to train the video data generation neural network 110, that is, to determine trained values of the network parameters 150 of the video data generation neural network 110 from initial values of the network parameters 150 of the video data generation neural network 110.

Specifically, the training engine 140 iteratively trains the video data generation neural network 110 by first generating a sequence of training video frames using the video data generation neural network 110 in accordance with current values of the video data generation network parameters, and then using the video data embedding neural network 130 to generate respective embeddings 114 for the sequence of training video frames. For each training video frame, the system can determine a similarity between the embedding of the training video frame and a corresponding embedding 134 generated by using video data embedding neural network 130 for a target video frame 124 obtained from the training data 120. For example, the training engine 140 can determine the similarity by computing a Frechet Distance, a dynamic time warping distance, an edit distance, a cosine similarity, a Kullback-Leibler (KL) divergence, a Euclidean distance, or a combination thereof between each pair of embeddings 132 and 134.

At the end of each training iteration, the training engine 140 can compute a gradient with respect to the network parameters 150 of an objective function that includes a term that depends on the similarity. The training engine 140 can determine the gradients 142 of the objective function using, e.g., backpropagation techniques.

In particular, in some implementations, the training engine 140 can use this similarity as a standalone training objective. That is, the training engine 140 evaluates a distance function which measures the similarity and then determines the update to network parameters 150 based on computing a gradient of the distance function with respect to the network parameters 150.

Alternatively, in some other implementations, the training engine 140 can modify any of a variety of existing objective functions suitable for training the video data generation neural network to incorporate this additional term and thereafter compute a gradient of the modified objective function with respect to the network parameters 150, including the network parameters of the video data generation neural network 110 and the network parameters of the video data embedding neural network 130.

For example, the existing objective function may be an objective function for training autoregressive models (e.g., as described in section 3.3 of Weissenborn, Dirk, Oscar Täckström, and Jakob Uszkoreit. “Scaling Autoregressive Video Models.” International Conference on Learning Representations. 2019).

As another example, the existing objective function may be an objective function for training flow-based generative models (e.g., as described in section 4.2 of Kumar, Manoj, et al. “VideoFlow: A Conditional Flow-Based Model for Stochastic Video Generation.” International Conference on Learning Representations. 2019).

As another example, the existing objective function may be an objective function under generative adversarial network framework (e.g., as described in section 3 of Tulyakov, Sergey, et al. “MoCoGAN: Decomposing motion and content for video generation.” Proceedings of the IEEE conference on computer vision and pattern recognition. 2018).

As another example, the existing objective function may be a supervised learning objective function, e.g., for training action recognition models.

As yet another example, the existing objective function may be a self-supervised learning objective function, e.g., for training frame prediction models.

The training engine 140 then uses the gradient 142 to update the values of the network parameters 150, e.g., based on an appropriate gradient descent optimization technique (e.g., an RMSprop or Adam optimization procedure). The provision of this additional term that depends on the similarity can provide richer and more reliable training signals, e.g., compared to objective functions that merely evaluate unsupervised or adversarial losses. This can stabilize the training and render the overall training more effective.

The training engine 140 can continue training the video data generation neural network 110 until a training termination criterion is satisfied, e.g., until a predetermined number of training iterations have been performed, or until the similarity between each pair of embeddings 132 and 134 is below a predetermined threshold.

In some implementations, after the video data generation neural network 110 has been trained in this manner, the system 100 deploys the trained neural network 110 and then uses the trained neural network 110 to process requests received from users, e.g., through the API provided by the system.

Instead of or in addition to using the trained neural network 110, the system 100 can provide data specifying the final parameter values to a user who submitted a request to train the neural network, e.g., through the API.

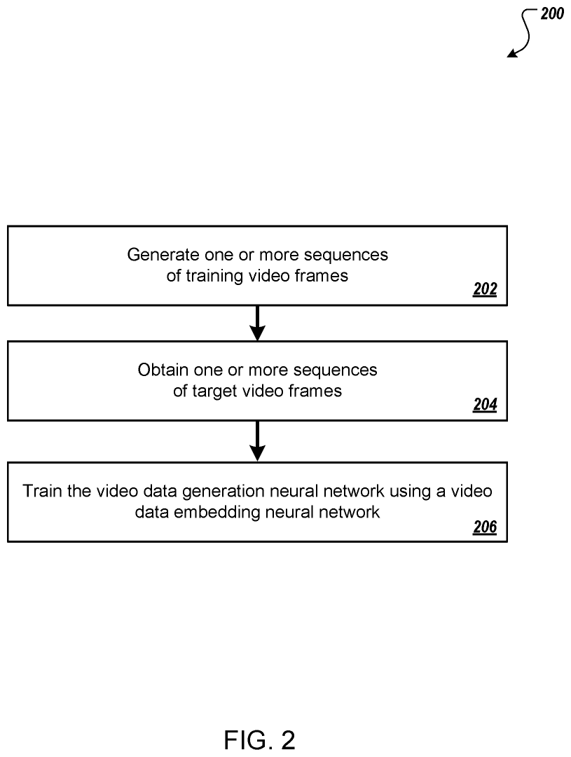

FIG. 2 is a flow diagram of an example process 200 for training a video data generation neural network. For convenience, the process 200 will be described as being performed by a system of one or more computers located in one or more locations. For example, a visual speech recognition system, e.g., the system 100 of FIG. 1, appropriately programmed in accordance with this specification, can perform the process 200.

The system generates one or more sequences of training video frames (202) using the video data generation neural network in accordance with current values of the video data generation network parameters. Each sequence of training video frame typically includes multiple video frames arranged according to a temporal order. In some implementations, to generate each training video frame, the system provides the network with a network input, e.g., an initial video frame, data derived from an initial video frame, or both, and processes the network input in accordance with current parameter values of the video data generation neural network to generate a network output that specifies the training video frame.

The system obtains one or more sequences of target video frames (204). For example, the system may receive the target video data through an API made available by the system, or from a dataset that is currently maintained by the system.

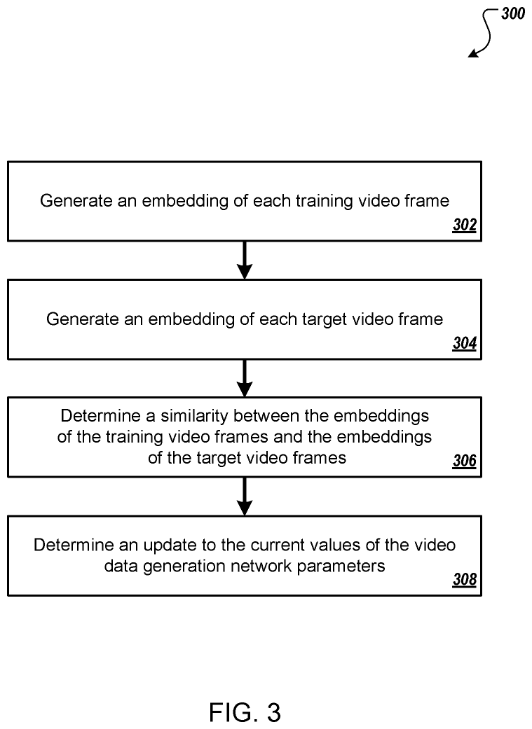

The system trains the video data generation neural network using the target video frames together with a video data embedding neural network (206) that is configured to generate an embedding of a video frame. In particular, and as will be further described below with reference to FIG. 3, the system trains the network according to a supervised learning training scheme in which some or all of the training objectives are derived from the target video frames based on processing the target video frames using the video data embedding neural network.

FIG. 3 is a flow diagram of an example process 300 for determining an update to the current values of the video data generation network parameters based on a similarity between the embeddings. For convenience, the process 300 will be described as being performed by a system of one or more computers located in one or more locations. For example, a visual speech recognition system, e.g., the system 100 of FIG. 1, appropriately programmed in accordance with this specification, can perform the process 300.

The system generates a respective embedding of each of the training video frames by processing the training video frame using the video data embedding network (302) and in accordance with the trained parameter values of the video data embedding neural network.

The system generates a respective embedding of each of the target video frames by processing a target video frame using the video data embedding network (304) and in accordance with the trained parameter values of the video data embedding neural network.

The system determines a similarity between the respective embeddings of the training video frames and the respective embeddings of the target video frames (306), e.g., based on evaluating a function that computes a Frechet Distance, a dynamic time warping distance, an edit distance, a cosine similarity, a Kullback-Leibler (KL) divergence, a Euclidean distance, or a combination thereof. As a particular example, the Frechet distance function measures a similarity between data distributions by taking into account the location and ordering of the data points along the distributions.

In cases where each target video frame in the sequence of target video frames is a ground truth output of a corresponding training video frame in the sequence of training video frames, the system can determine this similarity based on repeatedly comparing every pair of training and ground truth video frames. That is, the system can compute a pair-wise similarity between each pair of training and ground truth video frames and thereafter combines, e.g., by computing a weighted or unweighted sum or average of, the pair-wise similarities.

In some other cases, however, corresponding ground truth video frames are not available during the training. That is, video frames that perfectly match (e.g., spatially or temporally align with) the training video frames may be unavailable or insufficient in terms of data volume. In such cases, the system can evaluate the similarity as a collective similarity between respective embeddings for a set of training video frames and a suitable set of target video frames drawn from a target distribution, where each set can include multiple sequences of frames. Because the suitable set of target video frames does not correspond, the system can use the set of training video frames to cause the video generation neural network to generate video frames that appear to be from the target distribution. For example, the target video frames can be known, realistic video frames depicting a particular type of scene and the system can use the target video frames to cause the video generation neural network to generate video frames of the same type of scene that appear realistic.

For example, the system can combine, e.g., by computing a concatenation or a mean of, the embeddings for the video frames in each set and then compute a collective similarity between the two combined embedding. That is, the system can compare a combined embedding of the generated video frames to a combined embedding of the target video frames using one of the similarity measures described above.

As a particular example, in cases where the embeddings each parameterize a respective distribution over a set of possible values for each of multiple latent factors, the combined embedding for each set can in turn include multiple averaged distributions of all distributions parameterized by the embeddings for each of the multiple latent factors, and the collective similarity can be computed from respective similarities between the multiple averaged distributions for the two sets.

In this way, the system can use the video data embedding neural network to train the video data generation neural network to generate analogous video to any given target video data that is in fact available.

The system determines an update to the current values of the video data generation network parameters (308) based on determining, e.g., through backpropagation techniques, a gradient of an objective function that includes a term that depends on the similarity. In particular, to determine the update, the system can compute the gradient with respect to the video data embedding network parameters and thereafter backpropagate the gradient through network parameters of the video data embedding neural network into the network parameters of the video data generation neural network. Generally, the system keeps the parameter values of the already trained video data embedding neural network fixed and only adjusts the parameter values of the video data generation neural network during the training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices;

magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a video data generation neural network having a plurality of video generation network parameters, the method comprising:
generating one or more sequences of training video frames using the video data generation neural network in accordance with current values of the video data generation network parameters;
obtaining one or more sequences of target video frames; and
training the video data generation neural network using a video data embedding neural network configured to generate an embedding of a video frame, the training comprising:
generating a respective embedding of each of the training video frames by processing the training video frame using the video data embedding neural network;
generating a respective embedding of each of the target video frames by processing the target video frame using the video data embedding neural network;
determining a similarity between the respective embeddings of the training video frames and the respective embeddings of the target video frames; and
determining an update to the current values of the video data generation network parameters based on determining a gradient with respect to the video data generation network parameters of an objective function that includes a term that depends on the similarity.

2. The method of claim 1, wherein determining the similarity between the embedding of the training video frame and the embedding of the target video frame comprises:
computing a Frechet Distance between the respective embeddings of the training video frames and the respective embeddings of the target video frames.

3. The method of claim 1, wherein the video data generation neural network is configured to generate the training video frame based on processing an input video frame in accordance with the current values of the video data generation network parameters.

4. The method of claim 3, wherein the target video frame is an upsampled version of the input video frame.

5. The method of claim 3, wherein the target video frame comprises an additional content item compared to the input video frame.

6. The method of claim 3, wherein the target video frame is a compressed version of the input video frame.

7. The method of claim 1, wherein determining the update to the current values of the video data generation network parameters comprises:
backpropagating the gradient of the objective function through video data embedding network parameters of the video data embedding neural network into the video data generation network parameters of video generation neural network.

8. The method of claim 1, wherein the video data embedding network is part of a trained video processing neural network.

9. The method of claim 8, wherein the video processing neural network comprises one or more volumetric convolutional neural network layers each including a plurality of three-dimensional filters.

10. The method of claim 9, wherein the video processing neural network further comprises an output subnetwork configured to generate a video processing network output by processing the embedding generated by the video data embedding neural network, the output subnetwork comprising at least an output layer.

11. The method of claim 1, wherein the training comprises training the video data generation neural network on a single sequence of training video frames and a single sequence of target video frames that is a ground truth output corresponding to the sequence of training video frames, and wherein the similarity is a pair-wise similarity between the embedding of each training video frame and the embedding of a corresponding target video frame.

12. The method of claim 1, wherein the training comprises training the video data generation neural network on a plurality of sequences of training video frames and a plurality of sequences of target video frames, and wherein the similarity is a collective similarity between the embeddings of the training video frames and the embeddings of the target video frames.

13. A system comprising one or more computers and one or more storage devices storing instructions that when executed by the one or more computers cause the one or more computers to perform operations comprising:
generating one or more sequences of training video frames using the video data generation neural network in accordance with current values of the video data generation network parameters;
obtaining one or more sequences of target video frames; and
training the video data generation neural network using a video data embedding neural network configured to generate an embedding of a video frame, the training comprising:
generating a respective embedding of each of the training video frames by processing the training video frame using the video data embedding neural network;
generating a respective embedding of each of the target video frames by processing the target video frame using the video data embedding neural network;
determining a similarity between the respective embeddings of the training video frames and the respective embeddings of the target video frames; and
determining an update to the current values of the video data generation network parameters based on determining a gradient with respect to the video data generation network parameters of an objective function that includes a term that depends on the similarity.

14. One or more computer storage media storing instructions that when executed by one or more computers cause the one or more computers to perform operations comprising:
generating one or more sequences of training video frames using the video data generation neural network in accordance with current values of the video data generation network parameters;
obtaining one or more sequences of target video frames; and
training the video data generation neural network using a video data embedding neural network configured to generate an embedding of a video frame, the training comprising:
generating a respective embedding of each of the training video frames by processing the training video frame using the video data embedding neural network;
generating a respective embedding of each of the target video frames by processing the target video frame using the video data embedding neural network;
determining a similarity between the respective embeddings of the training video frames and the respective embeddings of the target video frames; and
determining an update to the current values of the video data generation network parameters based on determining a gradient with respect to the video data generation network parameters of an objective function that includes a term that depends on the similarity.

15. The system of claim 13, wherein determining the similarity between the embedding of the training video frame and the embedding of the target video frame comprises:
computing a Frechet Distance between the respective embeddings of the training video frames and the respective embeddings of the target video frames.

16. The system of claim 13, wherein the video data embedding network is part of a trained video processing neural network.

17. The system of claim 16, wherein the video processing neural network comprises one or more volumetric convolutional neural network layers each including a plurality of three-dimensional filters.

18. The system of claim 17, wherein the video processing neural network further comprises an output subnetwork configured to generate a video processing network output by processing the embedding generated by the video data embedding neural network, the output subnetwork comprising at least an output layer.

19. The system of claim 13, wherein the training comprises training the video data generation neural network on a single sequence of training video frames and a single sequence of target video frames that is a ground truth output corresponding to the sequence of training video frames, and wherein the similarity is a pair-wise similarity between the embedding of each training video frame and the embedding of a corresponding target video frame.

20. The system of claim 13, wherein the training comprises training the video data generation neural network on a plurality of sequences of training video frames and a plurality of sequences of target video frames, and wherein the similarity is a collective similarity between the embeddings of the training video frames and the embeddings of the target video frames.
